(19) United States
(12) Patent Application Publication
(10) Pub. No.: US 2008/0177776 A1
(43) Pub. Date: Jul. 24, 2008

(54) ANIMATION OBJECT SHELL SYSTEM AND METHOD

(76) Inventor: RICHARD W. STALLINGS, Plymouth, MI (US)

Correspondence Address: HOLLAND & KNIGHT LLP, 10 ST. JAMES AVENUE, 11th Floor, BOSTON, MA, 02116-3889, US

(21) Appl. No.: 11/740,578

(22) Filed: Apr. 26, 2007

Related U.S. Application Data
(63) Continuation-in-part of application No. 11/625,534, filed on Jan. 22, 2007.
(60) Provisional application No. 60/891,600, filed on Feb. 26, 2007.

(51) Int. Cl. G06F 7/00

(52) U.S. Cl. 707/102; 707/E17.005

(57) ABSTRACT

A method and computer program product for storing a plurality of animation object shells in a data repository. Each of the plurality of animation object shells includes at least one data object, and two or more discrete animation sequences for applying to at least a portion of the at least one data object.

### RELATED APPLICATIONS

This application claims priority to the following: U.S. patent application Ser. No. 11/625,534, filed 22 Jan. 2007, entitled “Data Presentation System and Method” (H&K Docket No.: 111228.00009); U.S. Patent Application Ser. No. 60/891,600, filed 26 Feb. 2007, entitled “System and Method for Preparing a Video Presentation” (H&K Docket No.: 111228.00010); and U.S. patent application Ser. No. 11/736,316, filed 17 Apr. 2007, entitled “Content Authoring System and Method” (H&K Docket No.: 111228.00004), which are herein incorporated by reference.

### TECHNICAL FIELD

This disclosure relates to object shells and, more particularly, to feature-rich animation object shells that assist in automating content production.

### BACKGROUND

When generating content, the creator of such content typically has the option of generating generic-looking content in a timely fashion or generating custom-looking content that requires various time-consuming content production techniques.

For example, generic-looking content may be quickly generated using a word processor, such as Microsoft Word™ or a presentation programs such as Microsoft PowerPoint™. However, the format of the content generated using e.g., either of these programs is typically quite constrained, in that these programs usually offer limited formatting capabilities.

Alternatively, when custom-looking content is desired, programs such as Adobe Photoshop™ may be used. However, these programs often require a high level of skill and considerable time to create such custom-looking content.

### SUMMARY OF DISCLOSURE

In a first implementation, an animation object shell method includes storing a plurality of animation object shells in a data repository. Each of the plurality of animation object shells includes at least one data object, and two or more discrete animation sequences for applying to at least a portion of the at least one data object.

One or more of the following features may be included. At least a portion of the plurality of animation object shells may be presented to a user for use in creating content. The content may be a slideshow presentation file and/or a word processor file. The at least one data object may include a first data object and a second data object. The two or more discrete animation sequences may include a first animation sequence for applying to the first data object, and a second animation sequence for applying to the second data object.

The at least one of the plurality of animation object shells may be configurable by a user. A specific animation object shell chosen from the plurality of animation object shells may be edited. Editing one or more of the plurality of animation object shells may include at least one of: adding one or more additional data objects to the specific animation object shell, adding one or more additional discrete animation sequences to the specific animation object shell; deleting one or more of the at least one data object from the specific animation object shell, and deleting one or more of the two or more discrete animation sequences from the specific animation object shell. Additional animation object shells may be defined for inclusion within the plurality of animation object shells. The data repository may be chosen from the group consisting of: a database and a directory structure.

In another implementation, an animation object shell includes at least one data object, and two or more discrete animation sequences for applying to at least a portion of the at least one data object.

One or more of the following features may be included. The at least one data object may include a first data object and a second data object. The two or more discrete animation sequences may include a first animation sequence for applying to the first data object and a second animation sequence for applying to the second data object.

In another implementation, a computer program product residing on a computer readable medium has a plurality of instructions stored on it. When executed by a processor, the instructions cause the processor to perform operations including storing a plurality of animation object shells in a data repository. Each of the plurality of animation object shells includes at least one data object, and two or more discrete animation sequences for applying to at least a portion of the at least one data object.

One or more of the following features may be included. At least a portion of the plurality of animation object shells may be presented to a user for use in creating content. The content may be a slideshow presentation file and/or a word processor file. The at least one data object may include a first data object and a second data object. The two or more discrete animation sequences may include a first animation sequence for applying to the first data object, and a second animation sequence for applying to the second data object.

The at least one of the plurality of animation object shells may be configurable by a user. A specific animation object shell chosen from the plurality of animation object shells may be edited. Editing one or more of the plurality of animation object shells may include at least one of: adding one or more additional data objects to the specific animation object shell, adding one or more additional discrete animation sequences to the specific animation object shell; deleting one or more of the at least one data object from the specific animation object shell, and deleting one or more of the two or more discrete animation sequences from the specific animation object shell. Additional animation object shells may be defined for inclusion within the plurality of animation object shells. The data repository may be chosen from the group consisting of: a database and a directory structure.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an animated object shell process coupled to a distributed computing network;

FIG. 2 is a flowchart of the animated object shell process of FIG. 1;

FIG. 3 is a diagrammatic view of a user interface screen rendered by the animated object shell process of FIG. 1;

FIG. 4 is a diagrammatic view of a screen rendered by the animated object shell process of FIG. 1;

FIG. 5 is a diagrammatic view of a screen rendered by the animated object shell process of FIG. 1;

FIG. 6 is a diagrammatic view of a screen rendered by the animated object shell process of FIG. 1;

FIG. 7 is a diagrammatic view of a screen rendered by the animated object shell process of FIG. 1;

FIG. 8 is a diagrammatic view of a screen rendered by the animated object shell process of FIG. 1;

FIG. 9 is a diagrammatic view of a screen rendered by the animated object shell process of FIG. 1;

FIG. 10 is a diagrammatic view of a screen rendered by the animated object shell process of FIG. 1; and

FIG. 11 is a diagrammatic view of a screen rendered by the animated object shell process of FIG. 1.

### DETAILED DESCRIPTION OF THE PREFERRED EMBODIMENTS

### System Overview:

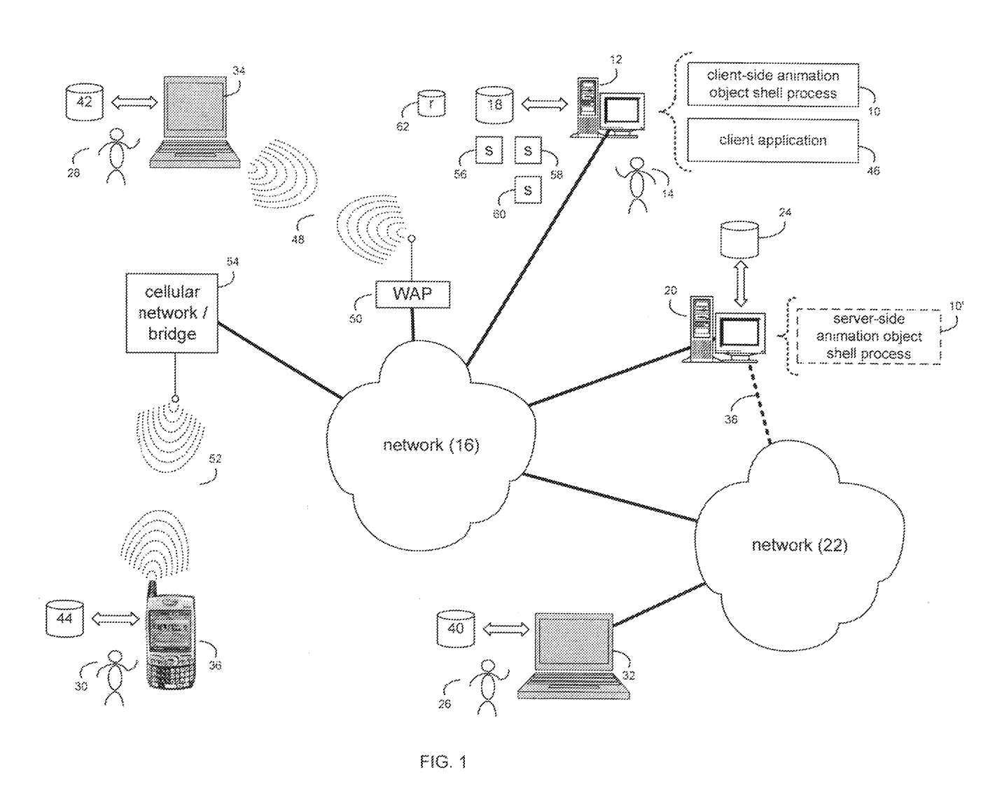

Referring to FIG. 1, there is shown an animated object shell process 10 that may reside on and may be executed by a computing device (e.g., client computer 12). Examples of computing devices may include, but are not limited to, personal computers, laptop computers, notebook computers, and personal digital assistants, for example. As will be discussed below in greater detail, animation object shell process 10 may allow a user 14 to define a plurality of animation object shells, each of which may include at least one data object, and two or more discrete animation sequences for applying to at least a portion of the at least one data object.

Animation object shell process 10 may be a client-side application that resides on and is executed by e.g., client computer 12, which may be connected to network 16 (e.g., the Internet). The instruction sets and subroutines of animation object shell process 10, which may be stored on a storage device 18 coupled to client computer 12, may be executed by one or more processors (not shown) and one or more memory architectures (not shown) incorporated into client computer 12. Storage device 18 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively, the above-described animation object shell process may be a server-based application, as represented in FIG. 1 by server-side animation object shell process 10′ (shown in phantom). Server-side animation object shell process 10′ may reside on and may be executed by data server 20, which may be coupled to network 16. Examples of data server 20 may include, but are not limited to: a personal computer, a server computer, a series of server computers, a mini computer, and a mainframe computer, for example. Data server 20 may execute a network operating system, examples of which may include but are not limited to: Microsoft Windows XP Server™; Novell Netware™; or Redhat Linux™, for example.

Data server 20 may execute a web server application, examples of which may include but are not limited to: Microsoft IIS™, Novell Webserver™, or Apache Webserver™, that allows for HTTP (i.e., HyperText Transfer Protocol) access to data server 20 via network 16. Network 16 may be coupled to one or more secondary networks (e.g., network 22), examples of which may include but are not limited to: a local area network; a wide area network; or an intranet, for example.

The instruction sets and subroutines of server-side animation object shell process 10′, which may be stored on a storage device 24 coupled to data server 20, may be executed by one or more processors (not shown) and one or more memory architectures (not shown) incorporated into data server 20. Storage device 24 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the animation object shell process may be a client-side application (e.g., client-side animation object shell process 10), a server-side application (e.g., server-side animation object shell process 10′), or a hybrid client-side/server-side application (e.g., using portions of both client-side animation object shell process 10 and server-side animation object shell process 10′). Accordingly, the manner in which the animation object shell process is accessed may vary depending on whether the animation object shell process is a client-side application, a server-side application, or a hybrid client-side/server-side application.

If a client-side application, users 14, 26, 28, 30 may access the client-side animation object shell process (e.g., client-side animation object shell process 10) directly through the device on which the client-side animation object shell process is executed, namely client computer 12, notebook computer 32, laptop computer 34 and personal digital assistant 36, for example. The instruction sets and subroutines of client-side animation object shell process 10, which may be stored on a storage device (e.g., storage device 18, 40, 42, 44) coupled to the computing device (e.g., client computer 12, notebook computer 32, laptop computer 34 and personal digital assistant 36, respectively) executing client-side animation object shell process 10, may be executed by one or more processors (not shown) and one or more memory architectures (not shown) incorporated into the computing device executing client-side animation object shell process 10. Storage devices 18, 40, 42, 44 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Alternatively, if a server-side application, users 14, 26, 28, 30 may access the server-side animation object shell process (e.g., server-side animation object shell process 10′) through network 16 or through secondary network 22. Data server 20 (i.e., the computer that executes server-side animation object shell process 10′) may be coupled to network 16 through secondary network 22, as illustrated with phantom link line 38.

If accessing server-side animation object shell process 10′, client computer 12, notebook computer 32, laptop computer 34 and personal digital assistant 36 may each execute a client application (e.g., client application 46) that may interface with server-side animation object shell process 10′ and facilitate the bidirectional transfer of data between e.g., client computer 12 and data server 20.

The client application (e.g., client application 46) may be a web browser (e.g., Microsoft Internet Explorer™ and Netscape Navigator™, for example), a stand alone application, or an applet running within another program (e.g., Microsoft Internet Explorer™ and Netscape Navigator™, for example).

Client computer 12, notebook computer 32, laptop computer 34 and personal digital assistant 36 may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 22). For example, client computer 12 is shown directly coupled to network 16 via a hardwired network connection, and notebook computer 32 is shown directly coupled to network 22 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

### The Animation Object Shell Process:

As discussed above, the animation object shell process may be a client-side application, a server-side application, or a hybrid client-side/server-side application. Accordingly, the following disclosure is applicable to all variants of the animation object shell process.

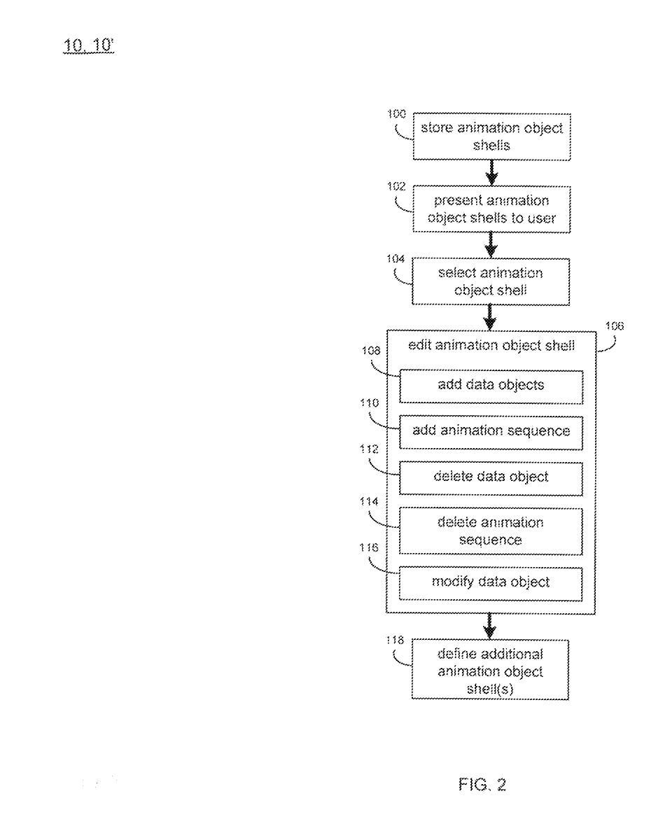

Referring also to FIG. 2, animation object shell process 10, 10′ may store 100 a plurality of animation object shells (e.g., shells 56, 58, 60) in a data repository 62. Examples of data repository 62 may include, but are not limited to, a database (e.g., an Oracle™ database, an IBM DB2™ database, a Sybase™ database, a Computer Associates™ database or a Microsoft Access™ database) or a traditional directory/subdirectory data structure. Data repository 62 may be included within storage device 18.

Each of the plurality of animation object shells (e.g., shells 56, 58, 60) may include at least one data object, and two or more discrete animation sequences for applying to at least a portion of the at least one data object. The animation object shells (e.g., shells 56, 58, 60) may allow the user (e.g., user 14) to control the manner in which data objects included within the content being generated by the user are manipulated. For example, through the use of an animation object shell (e.g., shells 56, 58, 60), the user (e.g., user 14) may control the manner in which one or more data objects included within a slide of a slideshow presentation are introduced. For example, if a slide within a slideshow presentation is to include photographs of the four founders of a company, the animation object shell (e.g., shell 56, 58, 60) may control the manner and sequence in which the individual photographs appear within the particular slide. For example, a first animation object shell (e.g., shells 56) may have each of the four photographs sequentially fade in. Alternatively, another animation object shell (e.g., shells 58) may have each of the four photographs slide into view from off screen.

Animation object shell process 10, 10′ may be a stand-alone application or may be a process incorporated into (i.e., executed within) another application, examples of which may include but are not limited to Microsoft Word™ and Microsoft PowerPoint™. Accordingly, when initiating animation object shell process 10, 10′, user 14 may launch animation object shell process 10, 10′ (if a stand-alone process) or may launch the application (Microsoft Word™ and Microsoft PowerPoint™) into which animation object shell process 10 is incorporated.

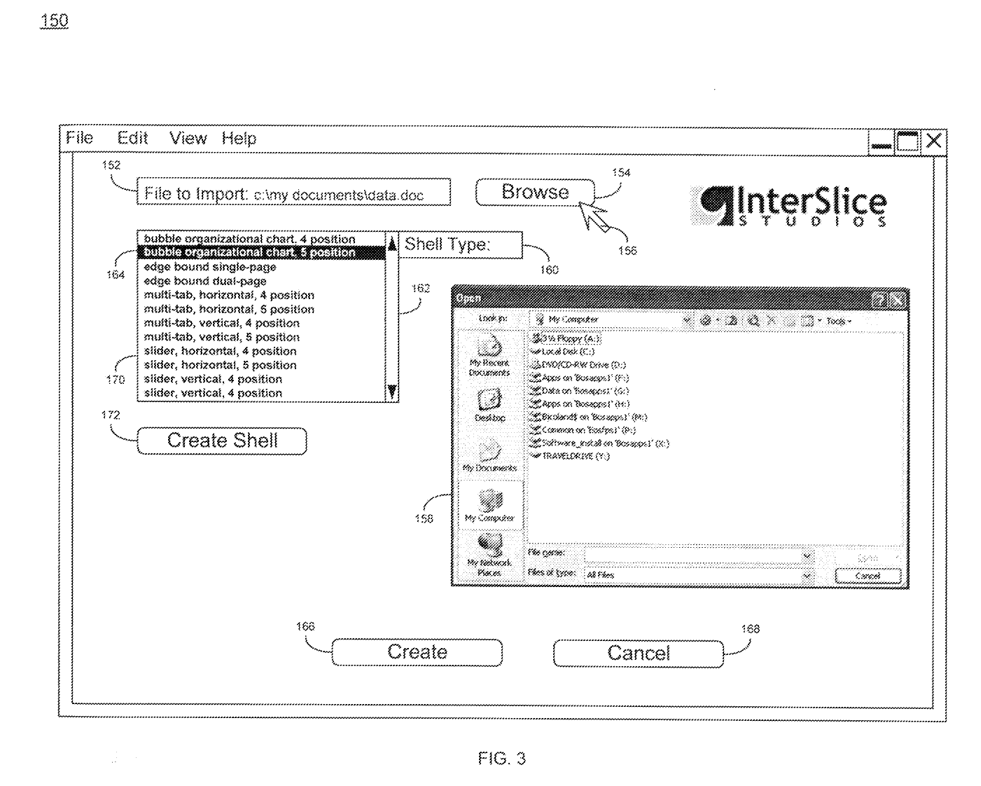

Referring also to FIG. 3, animation object shell process 10, 10′ may render user interface screen 150, which allows a user (e.g., user 14) to perform various tasks associated with generating content using one or more animation object shells (e.g., shells 56, 58, 60). Example of the type of content that may be generated may include, but are not limited to, a slideshow presentation file and/or a word processor file.

The manner in which user interface screen 150 is presented to the user may vary depending on whether the animation object shell process is a client-side application, a server-side application, or a hybrid client-side/server-side application. For example, if a client-side application, user interface 150 may be locally-rendered and presented to the user via e.g., locally-executed, client-side animation object shell process 10. Alternatively, if the animation object shell process is a server-side application, user interface 150 may be remotely-rendered and presented to the user via e.g., remotely-executed, server-side animation object shell process 10′. Further, if a hybrid client-side/server-side animation object shell process, user interface 150 may be locally-rendered and presented to the user via e.g., locally-executed, client-side animation object shell process 10. However, various animation object shells may be provided to client-side animation object shell process 10 by server-side animation object shell process 10′ via network 16 (or network 22).

When generating content, user interface screen 150 may allow the user (e.g., user 14) to import all or a portion of the data (e.g., text and/or images) to be included within the content. Accordingly, user interface screen 150 may include a “File to Import” field 152 that allows the user to define the location of a data file to be imported. The user may manually define the location of the data file by e.g., typing a path and file name (e.g., c:\my documents\data.doc) directly into field 152. Additionally/alternatively, user interface 150 may include a “Browse” button 154, which may be selectable via an onscreen pointer 156 that may be controllable by a pointing device such as a mouse (not shown). Once “Browse” button 154 is selected, a “browsing window” 158 may be rendered by animation object shell process 10, 10′. Browsing window 158 may allow the user to “browse” the directory structure of e.g., client computer 12 and define the data file for import. An example of a data file type that may be imported may include, but is not limited to, a word processing data file, such as those generated using Microsoft Word™ and/or a Joint Photographic Experts Group (i.e., JPEG) file.

Additionally/alternatively, animation object shell process 10, 10′ may allow the user to author the data to be included within the content. Therefore, if the user wishes to author (i.e., and not import) the data, the user may e.g., leave field 152 blank and, therefore, no data file will be imported.

Animation object shell process 10, 10′ may present 102 all or a portion of the available animation object shells (e.g., shells 56, 58, 60) included within data repository 62 to the user (e.g., user 14) for review and selection. User interface 150 may include e.g., a “Shell Type” field 160 that allows the user to select 104 an animation object shell for use in creating the content. When selecting “Shell Type” field 160 (using onscreen pointer 156), dropdown menu 162 may be rendered by animation object shell process 10, 10′ that defines a plurality of available animation object shells. For example and in this embodiment, dropdown menu 162 is shown to include twelve available animation object shells, namely: bubble organizational chart, 4 position; bubble organizational chart, 5 position; edge bound single-page; edge bound dual-page; multi-tab, horizontal, 4 position; multi-tab, horizontal, 5 position; multi-tab, vertical, 4 position; multi-tab, vertical, 5 position; slider, horizontal, 4 position; slider, horizontal, 5 position; slider, vertical, 4 position; and slider, vertical, 4 position. While this list is intended to be illustrative, it is not intended to be exhaustive. Accordingly, other animation object shells are considered to be within the scope of this disclosure.

Assume that, after reviewing dropdown menu 162, user 14 would like the content that they are creating (using animation object shell process 10, 10′) to include a five position bubble organizational chart. Accordingly, user 14 may select (using onscreen pointer 156) the “bubble organizational chart, 5 position” animation object shell line item 164 from the plurality of available animation object shells defined within dropdown menu 162.

Once the animation object shell line item 164 is selected and (if desired) the data to be imported is defined, the user may select (using onscreen pointer 156) “Create” button 166. Alternatively, user 14 may select “Cancel” button 168, which may e.g., terminate animation object shell process 10, 10′ or clear fields 152, 160.

If “Create” button 166 is selected, animation object shell process 10, 10′ may generate content in accordance with the animation object shell selected. As discussed above, in the event that no data file is selected for import, the content being generated may be “empty” of data (e.g., contain only blank fields). Accordingly and in this scenario, user 14 may be presented with an “empty” content shell (i.e., a shell that contains no data but is formatted in accordance with the selected animation object shell). Assuming that user 14 selected a data file for import (e.g., c:\my documents\data.doc), upon selecting “Create” button 166, animation object shell process 10, 10′ may generate a content shell that is wholly or partially filled with data.

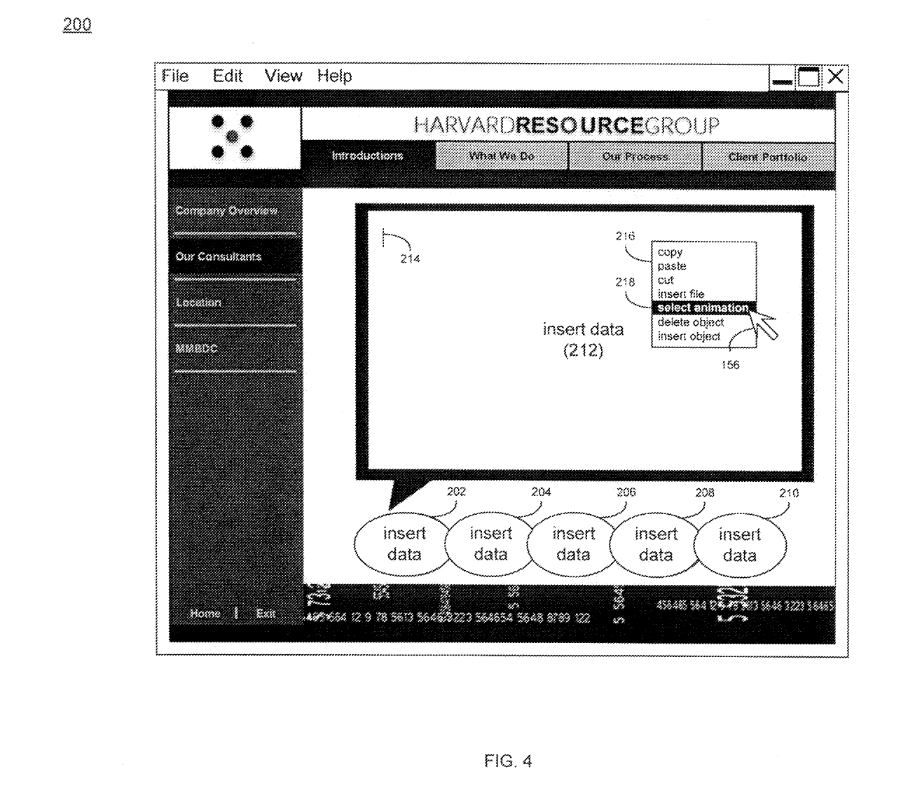

Continuing with the above-stated example and referring also to FIG. 4, “bubble organizational chart, 5 position” animation object shell 200 may be rendered by animation object shell process 10, 10′. Animation object shell 200 may include one or more data objects, and various animation sequences that may be applied to the data object(s) included within the shell. In this particular example, animation object shell 200 is shown to include five data “bubbles” 202, 204, 206, 208, 210, each of which may be associated with one or more data boxes. For example, data “bubble” 202 may be associated with data box 212, and each of data “bubbles” 204, 206, 208, 210 may be associated with other unique data boxes (not shown). Accordingly, by selecting data “bubble” 202, data box 212 may be rendered by animation object shell process 10, 10′; and by selecting data “bubble” 204, a different data box (not shown) may be rendered by animation object shell process 10, 10′, for example. Accordingly, when selecting data “bubble” 202, an animation sequence may be initiated that results in the rendering of data box 212. This animation sequence (when initiated) may result in e.g., data box 212 fading into view, sliding into view from the left, or sliding into view from the right.

Animation object shell process 10, 10′ may allow e.g., user 14 to edit 106 animation object shell 200, which may include e.g., populating the various data boxes/“bubbles” included within shell 200; adding 108 data objects and/or adding 110 animation sequences to shell 200; deleting 112 data objects and/or deleting 114 animation sequences from shell 200; and/or modifying 116 data objects. Examples of the types of modifications that may be made to data objects may include, but are not limited to: changing the color of an object; changing the color of text; changing the text itself; changing the font of text; changing the image in/on an object; changing the location of an object; and changing the type of animation on an object.

When populating a data box/“bubble” with data, the data may include, but is not limited to, text-based data, image-based data, video-based data, and/or audio-based data. As discussed above, this data may be imported in file format or manually entered. To populate a data box/“bubble”, user 14 may select the data box/“bubble” using onscreen pointer 156. Once selected, cursor 214 may appear within e.g., data box 212 that allows user 14 to enter text. Additionally/alternatively, user 14 may enter non-text data by e.g., “right clicking” the pointing device (not shown) while onscreen pointer 156 is above the data object into which the data is to be placed. “Right clicking” may result in the generation of popup menu 216. Popup menu 216, which may be rendered by animation object shell process 10, 10, may include a plurality of options, such as: “copy”, “paste”, “cut”, and “insert file”. By selecting e.g., “insert file”, a file selection window (not shown), that may be similar to “browsing window” 158 (FIG. 3) may be rendered by animation object shell process 10, 10′, which may allow user 14 to select the file to be inserted. As discussed above, the file to be inserted may be a text-based file (e.g., a Microsoft Word™ file), an image-based file (e.g., a JPEG file), a video-based file (e.g., a AVI file), and/or an audio-based file (e.g., an MP3 file), for example.

Popup window 216 may additionally include a “select animation” option 218 that may allow user 14 to select the animation associated with the data box/“bubble” (in this example) within the shell (e.g., shell 200) being edited 106. For example, by selecting “select animation” from popup window 216, user 14 may be presented with an animation selection window (not shown) that allows user 14 to select for various different animation sequences for the object in question. For example, user 14 may be allowed to select between various animation sequences, examples of which may include but are not limited to: fade in, fade out, slide in left, slide in right, slide in top, slide in bottom, slide out left, slide out right, slide out top, and slide out bottom, for example.

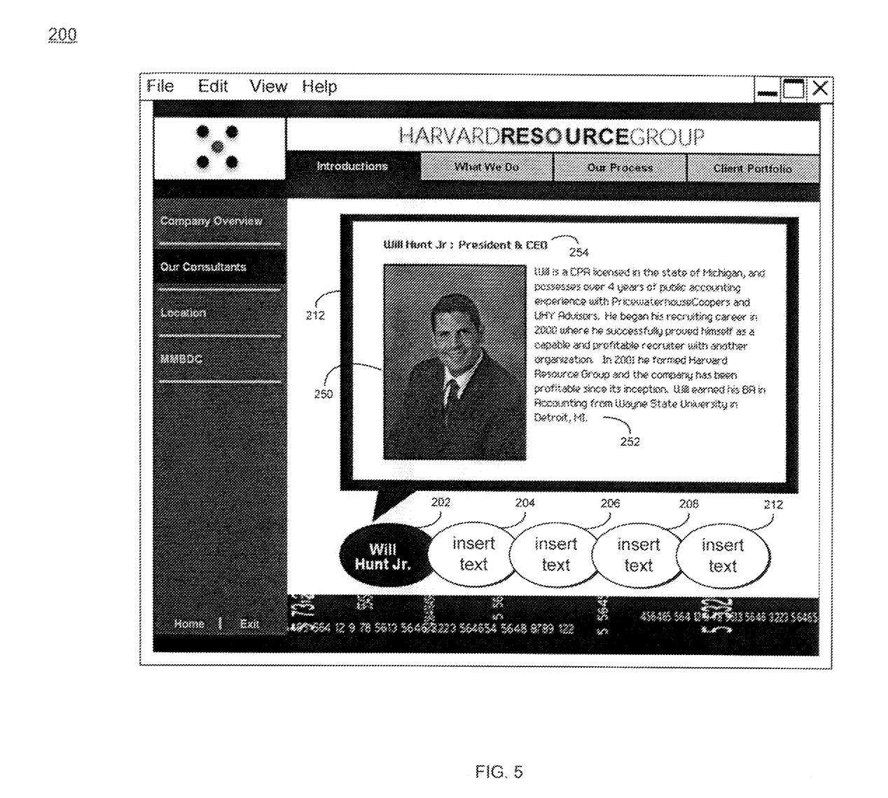

Referring also to FIG. 5, a completed data box (i.e., data box 212) and a completed data “bubble” (i.e., data bubble 202) are shown. In this particular example, data “bubble” 202 is populated with name information (e.g., “Will Hunt Jr.”) and data box 212 is populated with photograph 250, biographical information 252, and title information 254.

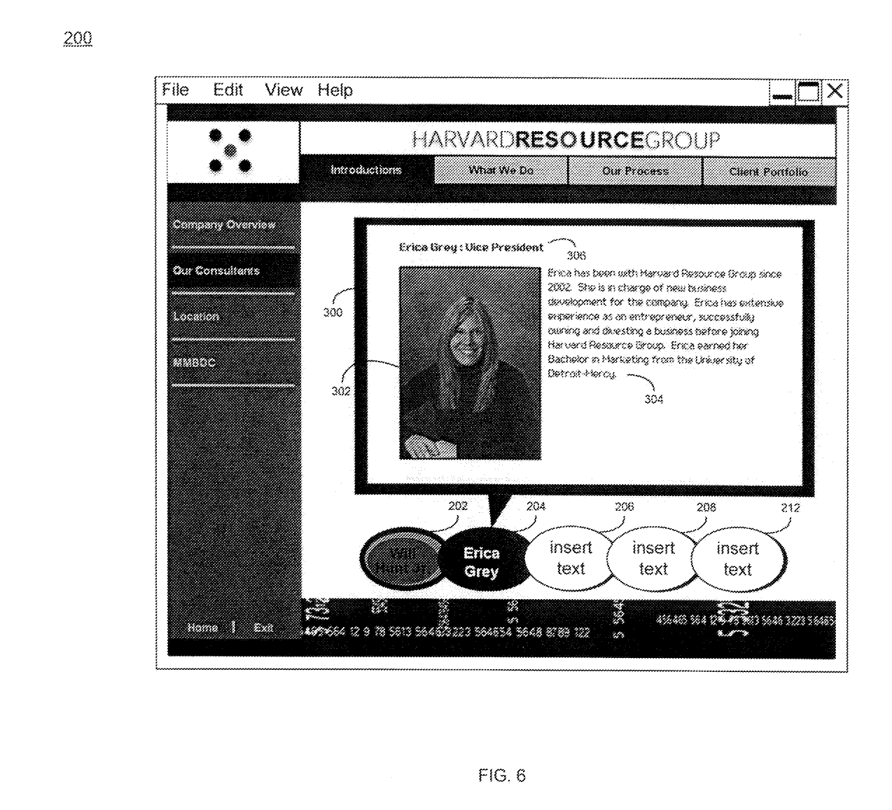

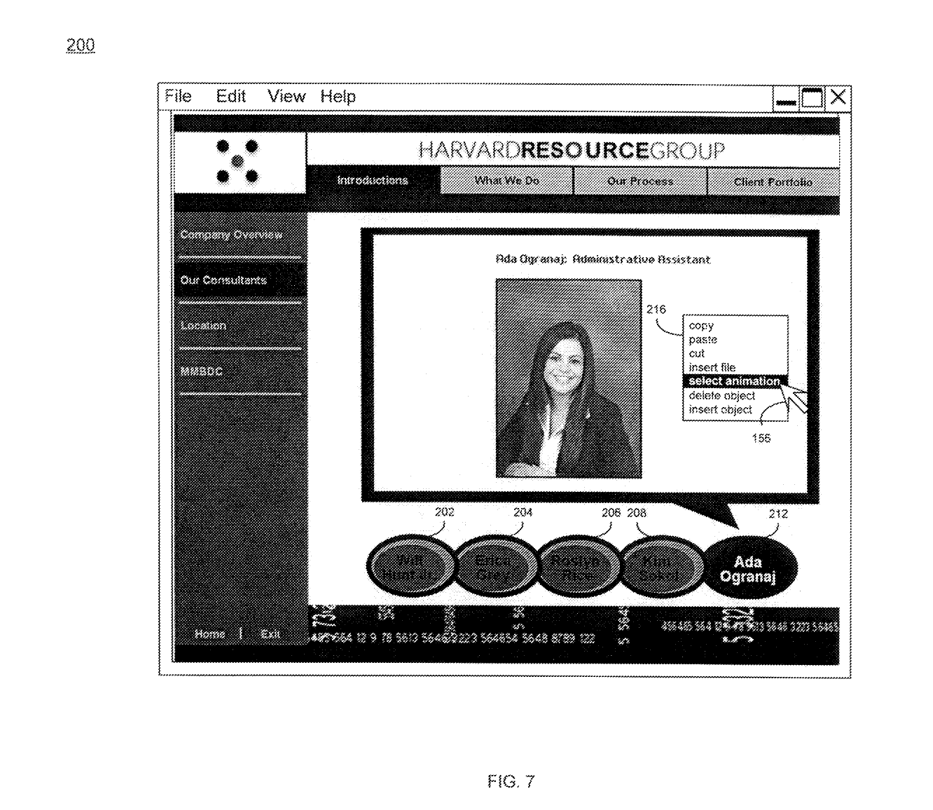

Referring also to FIG. 6, once e.g., data “bubble” 202 and data box 212 are populated with data, user 14 may select e.g., data “bubble” 204. Once selected, animation object shell process 10, 10′ may render data box 300 (i.e., the data box associated with data “bubble” 204). As discussed above, user 14 may populate data “bubble” 204 with name information (e.g., “Erica Grey”) and data box 212 may be populated with photograph 302, biographical information 304, and title information 306. As discussed above, user 14 may select the animation sequence to be associated with e.g., data box 300. Referring also to FIG. 7, this process may be continued until each data “bubble” and each data box (associated with each data bubble) is populated.

As discussed above, animation object shell process 10, 10′ may allow e.g., user 14 to edit 106 animation object shell 200, which may include: e.g., populating the various data boxes/“bubbles” included within shell 200; adding 108 data objects to shell 200; adding 110 animation sequences to shell 200; deleting 112 data objects from shell 200; deleting 114 animation sequences from shell 200; and/or modifying 116 data objects. Accordingly, in the event a data “bubble” and/or a data box needs to be added 108 or removed 112, user 14 may “right click” the pointing device (not shown) and animation object shell process 10, 10′ may render popup menu 216. User 14 may then select (using onscreen pointer 156) either “delete object” (e.g., to delete the object positioned beneath onscreen point 156) or “insert object” (e.g., to insert a data “bubble” and/or a data box). As discussed above, being a data object may have an animation sequence associated with it, when adding 108 a new data object, animation object shell process 10, 10′ may allow user 14 to add 110 a new animation sequence for association with the newly-added data object.

As discussed above and as illustrated in FIG. 3, animation object shell process 10, 10′ may allow user 14 to select from a plurality of animation object shells, examples of which include but are not limited to: bubble organizational chart, 4 position; bubble organizational chart, 5 position; edge bound single-page; edge bound dual-page; multi-tab, horizontal, 4 position; multi-tab, horizontal, 5 position; multi-tab, vertical, 4 position; multi-tab, vertical, 5 position; slider, horizontal, 4 position; slider, horizontal, 5 position; slider, vertical, 4 position; and slider, vertical, 4 position. While this list is intended to be illustrative, it is not intended to be exhaustive. Accordingly, other animation object shells are considered to be within the scope of this disclosure.

Accordingly, assuming that user 14 completes the previously-selected “bubble organization chart, five position”, user 14 may select an additional animation object shell. For example, assume that user 14 selects the “slider, horizontal, 4 position” line item 170 (FIG. 3).

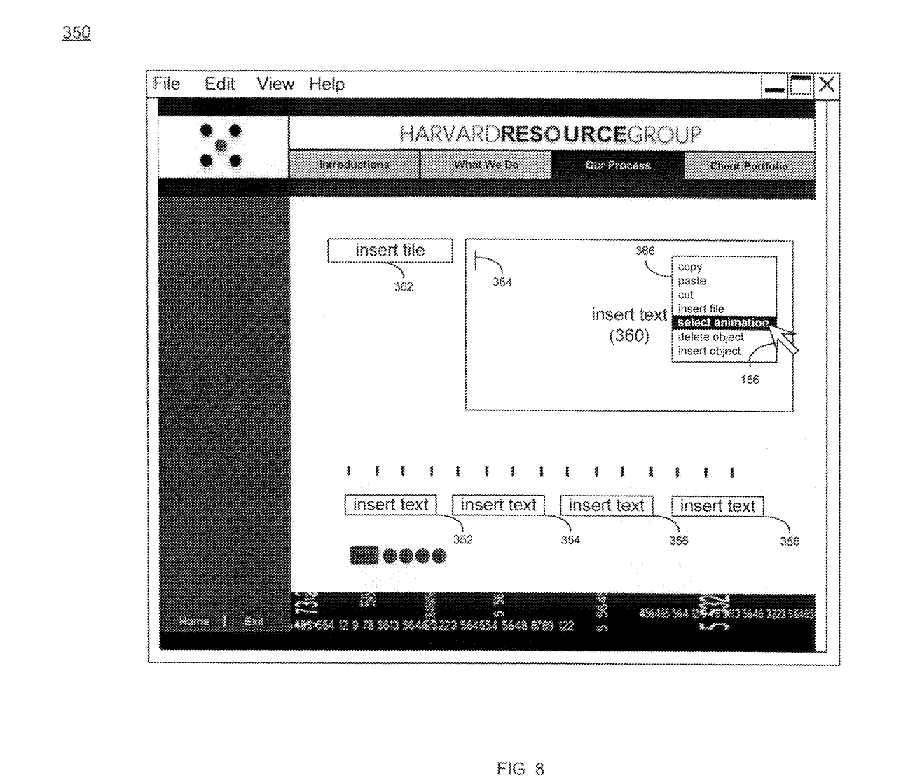

Continuing with the above-stated example and referring also to FIG. 8, “slider, horizontal, 4 position” animation object shell 350 may be rendered by animation object shell process 10, 10′. An animation object shell 350 may include one or more data objects, and a various animation sequences that may be applied data object(s). In this particular example, animation object shell 350 is shown to include four slider data boxes 352, 354, 356, 358, each of which may be associated with one or more data boxes. For example, slider data box 352 is associated with data boxes 360, 362 and each of slider data boxes 354, 356, 358 may be associated with other unique data boxes (not shown). Accordingly, by selecting: slider data box 352, data boxes 360, 362 may be rendered by animation object shell process 10, 10′; and by selecting slider data box 354, a different data box (not shown) may be rendered by animation object shell process 10, 10′, for example. Accordingly, when selecting slider data box 352, an animation sequence may be initiated that may result in the rendering on data boxes 360, 362. This animation sequence (when imitated) may result in e.g., data boxes 360, 362 fading into view, sliding into view from the left, or sliding into view from the right, for example.

Animation object shell process 10, 10′ may allow e.g., user 14 to edit 106 animation object shell 350, which may include e.g., populating the various data boxes included within shell 350; adding 108 data objects and/or adding 110 animation sequences to shell 350; deleting 112 data objects and/or deleting 114 animation sequences from shell 350; and/or modifying 116 data objects. As discussed above, user 14 may select the data box using onscreen pointer 156. Once selected, cursor 364 may appear within e.g., data box 360 that allows user 14 to enter text. Additionally/alternatively, user 14 may enter non-text data by e.g., “right clicking” the pointing device (not shown) while onscreen pointer 156 is above the object into which the data is to be placed. “Right clicking” may result in the generation of popup menu 366. Popup menu 366 may include a plurality of options, such as: “copy”, “paste”, “cut”, and “insert file”. By selecting e.g., “insert file”, a file selection window (not shown), that may be similar to “browsing window” 158 (FIG. 3) may be rendered by animation object shell process 10, 10′, which may allow user 14 to select the file to be inserted.

As discussed above, popup window 366 may additionally include a “select animation” option that may allow user 14 to select the animation associated with the data box being edited.

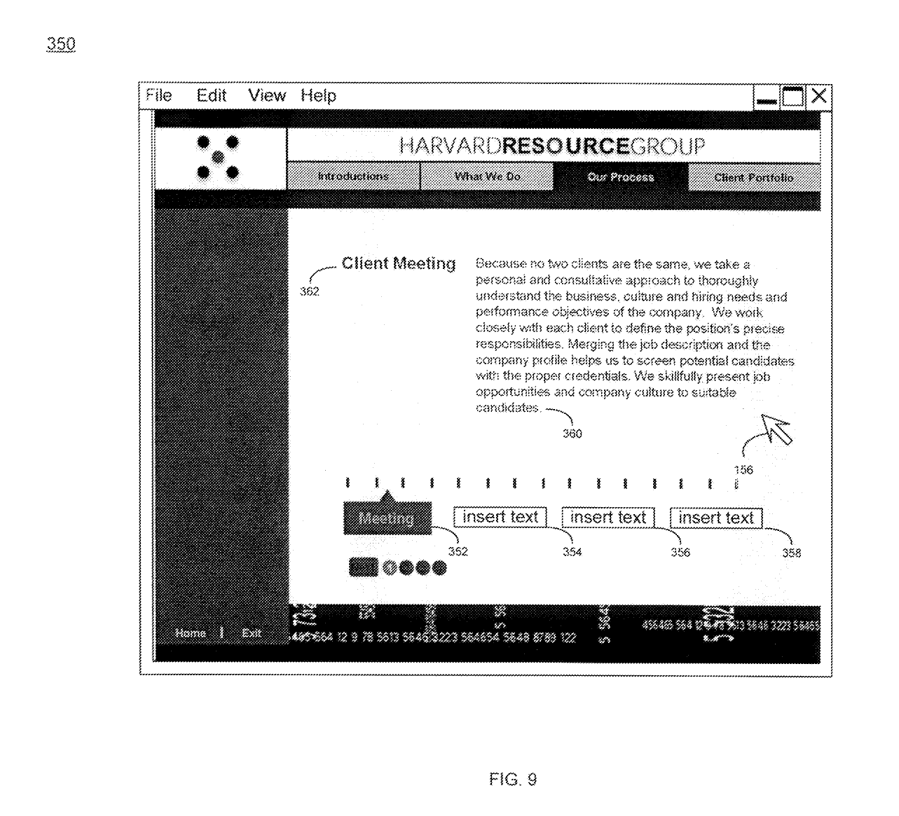

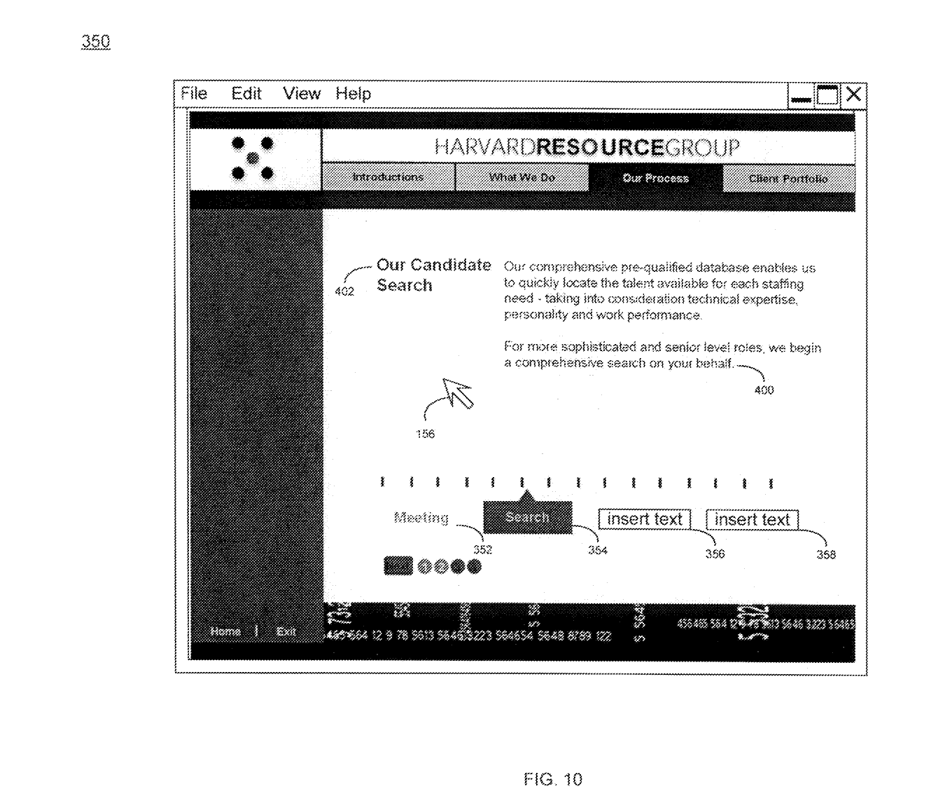

Referring also to FIGS. 9-10, there is shown shell 350 at various stages of completion. For example, FIG. 9 illustrates shell 350 after data boxes 352, 360, 362 have been populated with (in this example) text. Further, FIG. 10 illustrates shell 350 after slider data box 354 and data boxes 400, 402 (i.e., the data boxes associated with slider data box 354) have been populated with (in this example) text.

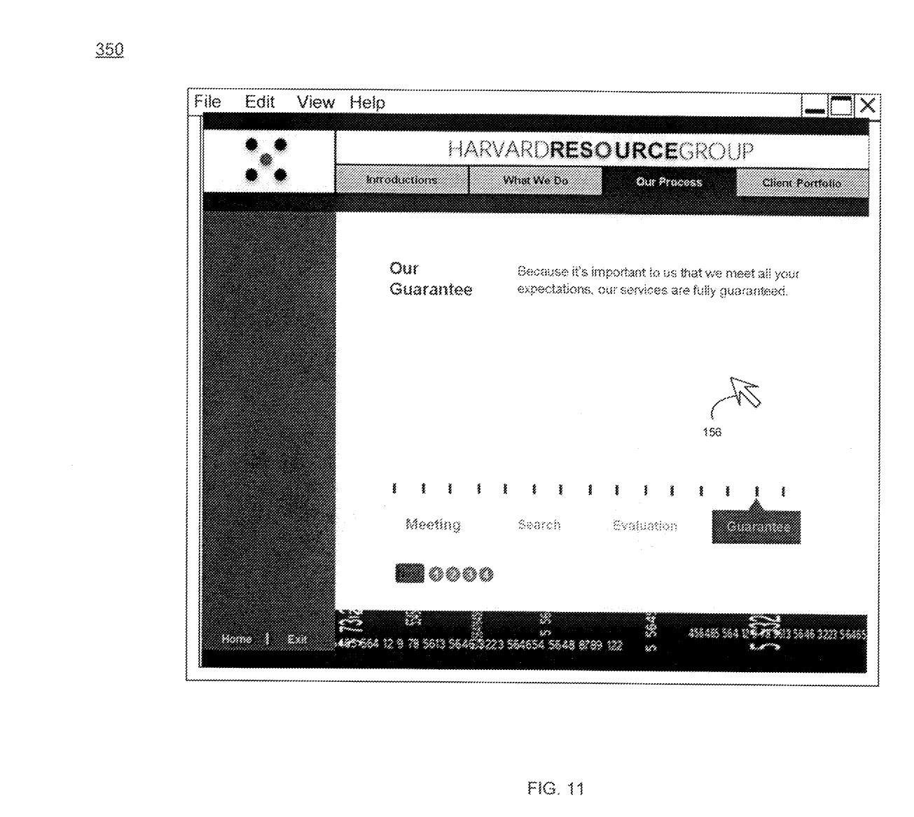

Referring also to FIG. 11, this process may be continued until each slider data box and each data box (associated with each slider data box) is populated.

The content produced using animation object shell process 10, 10′ may be exported for use in another program, such as the video presentation system described in U.S. Patent Application Ser. No. 60/891,600, filed 26 Feb. 2007, entitled “System and Method for Preparing a Video Presentation” (H&K Docket No.: 111228.00010).

Referring again to FIG. 3, while animation object shell process 10, 10′ provides a plurality of animation object shells (illustrated within dropdown menu 162), animation object shell process 10, 10′ may allow user 14 to define 118 custom shells. For example, user 14 may select “Create Shell” button 172 using onscreen pointer 156. Once selected, an animation object shell authoring screen (not shown) may be rendered by animation object shell process 10, 10′ that allows e.g., user 14 to define 118 additional animation object shells for inclusion within the plurality of animation object shells defined within dropdown menu 162.

A number of implementations have been described. Nevertheless, it will be understood that various modifications may be made. Accordingly, other implementations are within the scope of the following claims.

What is claimed is:

1. An animation object shell method comprising:
storing a plurality of animation object shells in a data repository, wherein each of the plurality of animation object shells includes:
at least one data object, and
two or more discrete animation sequences for applying to at least a portion of the at least one data object.

2. The method of claim 1 further comprising:
presenting at least a portion of the plurality of animation object shells to a user for use in creating content.

3. The method of claim 2 wherein the content is a slideshow presentation file.

4. The method of claim 2 wherein the content is a word processor file.

5. The method of claim 1 wherein the at least one data object includes:
a first data object, and
a second data object; and
wherein the two or more discrete animation sequences includes:
a first animation sequence for applying to the first data object, and
a second animation sequence for applying to the second data object.

6. The method of claim 1 wherein at least one of the plurality of animation object shells is configurable by a user, the method further comprising:
editing a specific animation object shell chosen from the plurality of animation object shells.

7. The method of claim 6 wherein editing one or more of the plurality of animation object shells includes at least one of:
adding one or more additional data objects to the specific animation object shell,
adding one or more additional discrete animation sequences to the specific animation object shell;
deleting one or more of the at least one data object from the specific animation object shell;
deleting one or more of the two or more discrete animation sequences from the specific animation object shell; and
modifying one or more of the at least one data object from the specific animation object shell.

8. The method of claim 1 further comprising:
defining additional animation object shells for inclusion within the plurality of animation object shells.

9. The method of claim 1 wherein the data repository is chosen from the group consisting of: a database and a directory structure.

10. An animation object shell comprising:
at least one data object, and
two or more discrete animation sequences for applying to at least a portion of the at least one data object.

11. The animation object shell of claim 10 wherein the at least one data object includes:
a first data object; and
a second data object.

12. The animation object shell of claim 11 wherein the two or more discrete animation sequences includes:
a first animation sequence for applying to the first data object; and
a second animation sequence for applying to the second data object.

13. A computer program product residing on a computer readable medium having a plurality of instructions stored thereon that, when executed by a processor, cause the processor to perform operations comprising:
storing a plurality of animation object shells in a data repository, wherein each of the plurality of animation object shells includes:
at least one data object, and
two or more discrete animation sequences for applying to at least a portion of the at least one data object.

14. The computer program product of claim 13 further comprising instructions for:
presenting at least a portion of the plurality of animation object shells to a user for use in creating content.

15. The computer program product of claim 14 wherein the content is a slideshow presentation file.

16. The computer program product of claim 14 wherein the content is a word processor file.

17. The computer program product of claim 13 wherein the at least one data object includes:
a first data object, and
a second data object; and
wherein the two or more discrete animation sequences includes:
a first animation sequence for applying to the first data object, and
a second animation sequence for applying to the second data object.

18. The computer program product of claim 13 wherein at least one of the plurality of animation object shells is configurable by a user, the computer program product further comprising instructions for:
editing a specific animation object shell chosen from the plurality of animation object shells.

19. The computer program product of claim 18 wherein the instructions for editing one or more of the plurality of animation object shells includes instructions for at least one of:
adding one or more additional data objects to the specific animation object shell,
adding one or more additional discrete animation sequences to the specific animation object shell;
deleting one or more of the at least one data object from the specific animation object shell, and
deleting one or more of the two or more discrete animation sequences from the specific animation object shell; and
modifying one or more of the at least one data object from the specific animation object shell.

20. The computer program product of claim 13 further comprising instructions for:
defining additional animation object shells for inclusion within the plurality of animation object shells.

21. The computer program product of claim 13 wherein the data repository is chosen from the group consisting of: a database and a directory structure.
